(19) United States
(12) Patent Application Publication
(10) Pub. No.: US 2020/0189946 A1
(43) Pub. Date: Jun. 18, 2020

(54) Effective Treatment of Food Waste and its Wastewater Using a Durable Biocarrier with High Microbial Loading

(71) Applicant: Nano and Advanced Materials Institute Limited, Hong Kong (CN)

(72) Inventors: Sui Han SIN, Hong Kong (CN); Guozhuangqi YAN, Hong Kong (CN); Sik Churi Johnny LO, Hong Kong (CN); Tong GUO, Hong Kong (CN); Yeuk Tin LAU, Hong Kong (CN)

(21) Appl. No.: 16/613,289

(22) PCT Filed: May 15, 2018
(86) PCT No.: PCT/CN2018/086913

§ 371 Date: Nov. 13, 2019

Related U.S. Application Data
(60) Provisional application No. 62/602,992, filed on May 15, 2017.

(51) Int. Cl. C02F 3/10; C02F 3/28; C02F 3/34

(52) U.S. Cl. CPC C02F 3/108; C02F 3/2846; C02F 2103/32; C02F 3/107; C02F 3/34; C02F 3/109

(57) ABSTRACT

The present disclosure relates to biocarriers with high microbial loading and durability useful for waste treatment, waste treatment systems comprising the same, and methods of use thereof.

### CROSS-REFERENCE TO RELATED APPLICATIONS

This application claims the benefit of priority of U.S. provisional application No. 62/602,992, filed May 15, 2017, the contents of which are incorporated herein by reference in their entirety.

### FIELD OF THE INVENTION

The present disclosure relates to a durable biocarrier useful for the treatment of waste water (including organics, solid food waste and its wastewater). The biocarriers described herein are suitable for the application in food waste treatment systems, such as food wastewater treatment facilities and consumer waste disposal systems (with or without mechanical mixing) and food waste composters.

### TECHNICAL BACKGROUND OF THE INVENTION

Food waste is a serious global environmental issue. For example, in Hong Kong, with a population of just over 7.3 million people in 2016, over 3,600 tons of food waste was disposed at landfills every day. This number is expected to increase even higher as the population grows. Given the growing need for adequate disposal systems and limited land set aside for waste disposal, a proliferation of food waste treatment is expected. As part of this effort, a number of on-site food waste decomposers are being promoted to consumer, commercial, and industrial sectors, which are capable of breaking down the extremely high organic content and volume of food waste, making it safer and more economic to dispose.

Food waste treatment systems can accelerate the decomposition of food waste to inert materials through microbial decomposition reactions of the organic materials in the food waste. However their performance is restricted by the limited microbial loading capacity of the treatment system. In these systems, microbes are typically grown on a large number of biocarriers, which are typically made from plastic grains with a large surface area. A number of biocarriers have been developed and are used in industrial waste treatment systems, such as the AnoxKaldnes K1, K3, K5, BiofilmChip M, and the Z-MBBR. However, due to low microbial loading capacity of conventional biocarriers, nearly half volume of a typical food waste treatment system is occupied by biocarriers. This results in higher operational cost and larger foot prints for food waste systems employing traditional plastic grains as biocarriers.

High microbial loading capacity of the biocarriers have been developed using highly porous materials, such as silicates. However, as a result of the large number of collisions between the biocarriers in conventional food waste treatment systems, these highly porous biocarriers experience a large amount of wear and consequently must be replaced more regularly. This results in more downtime and increased cost of the food waste treatment system.

To enhance food waste treatment performance and to reduce operational costs, the microbial loading capacity inside the food waste treatment system must be increased and the durability of the biocarriers improved. Thus, there exists a need for improved biocarriers with high microbial capacity and durability.

Existing food waste treatment methods typically produce unwanted wastewater leachate as a by-product, which is also heavily concentrated in organic matter. The wastewater chemical oxygen demand (COD) can exceed the discharge standard in many countries/regions. The direct disposal of this discharge into inland or open waters creates secondary water pollution problems, such as eutrophication and freshwater contamination.

Up-flow anaerobic sludge blanket (UASB) reactors are well-established economic systems for the treatment of high organic strength wastewater. Over 1,000 full scale industrial anaerobic UASB reactors have been in operation throughout the world since the 1970s for wastewater applications mostly used in connection with the brewery, beverage industry, food, pulp, and paper industries. UASB systems utilize anaerobic microbial digestion for converting the waste to biogas (methane), which can be used as an energy source.

One of the largest challenges to operating a UASB reactor is maintaining a high microbial concentration inside the reactor. To achieve a high microbial loading, granulation of microbes is usually required. However, microbe granulation is affected by serval factors, such as system pH and wastewater properties and under certain conditions, the granule can disintegrate and be expelled from the system. The use of biocarriers can aid in maintaining microbe density and retention. Thus, there exists a need to develop biocarriers with improved

### SUMMARY OF THE INVENTION

It is an object of the present disclosure to provide a biocarrier with enhanced microbial capacity and durability for use in treating organics in waste water, such as food waste and wastewater generated from food waste treatment for use in waste treatment systems, such as a UASB.

In a first aspect, provided herein is a biocarrier comprising: a shell comprising a polymeric material; and one or more cores comprising a porous material for attaching microorganisms, wherein the one or more cores are at least partially enclosed by the shell such that the one or more cores are accessible from an external environment, wherein at least one of the one or more cores defines a first axis and opposing surfaces along the first axis, such that the opposing surfaces are exposed to the external environment.

In a first embodiment of the first aspect, provided herein is the biocarrier of the first aspect, wherein at least one of the one or more cores is a continuous porous material or has a through hole along the first axis.

In a second embodiment of the first aspect, provided herein is the biocarrier of the first aspect, wherein the core is a cylinder configured longitudinally along the first axis; having opposing end surfaces exposed to the external environment; and a lateral surface.

In a third embodiment of the first aspect, provided herein is the biocarrier of the second embodiment of the first aspect, wherein the core is engaged with the shell via the lateral surface of the core.

In a fourth embodiment of the first aspect, provided herein is the biocarrier of the first aspect, wherein the shell has a plurality of protrusions along its perimeter and one or more through holes for receiving the one or more cores.

In a fifth embodiment of the first aspect, provided herein is the biocarrier of the first aspect, wherein the shell is gear-shaped with a plurality of teeth extending from an outer surface of the shell and the shell has a cylindrically shaped through hole at the center of the shell for receiving the core, wherein the core is cylindrically shaped.

In a sixth embodiment of the first aspect, provided herein is the biocarrier of the fifth embodiment of the first aspect, wherein the shell comprises four or more teeth.

In a seventh embodiment of the first aspect, provided herein is the biocarrier of the sixth embodiment of the first aspect, wherein each tooth of the gear-shaped shell extends from the outer surface of the shell by 3 to 4 mm.

In an eighth embodiment of the first aspect, provided herein is the biocarrier of the fifth embodiment of the first aspect, wherein each tooth of the gear-shaped shell has a tooth base width of 3 to 4 mm and a tooth face width of 1 to 2 mm.

In a ninth embodiment of the first aspect, provided herein is the biocarrier of the eighth embodiment of the first aspect, wherein each tooth is separated by a distance of 1 to 2 mm when measured at the base of the tooth.

In a tenth embodiment of the first aspect, provided herein is the biocarrier of the first aspect, wherein the polymeric material is polytetrafluoroethylene (PTFE), acrylonitrile butadiene styrene (ABS), polypropylene (PP), poly(methyl methacrylate) (PMMA), polyethylene (PE), polyvinylchloride (PVC), nylon, or a combination thereof.

In an eleventh embodiment of the first aspect, provided herein is the biocarrier of the first aspect, wherein the porous material comprises a ceramic, a silica, sintered glass, zeolite, diatomaceous earth, activated carbon, bone char, cement, or combinations thereof.

In a twelfth embodiment of the first aspect, provided herein is the biocarrier of the first aspect, wherein the polymeric material is nylon 6,6; the porous material comprises aluminum silicate or sintered glass; the nylon 6,6 and the aluminum silicate or sintered glass are present in a volumetric ratio of about 1:4 to about 1:5; the outer-surface of the shell is gear-shaped with at least six teeth extending between 3-4 mm from the surface of the shell, wherein each tooth of the gear-shaped shell has a tooth base width of 3 to 4 mm and a tooth face width of 1 to 2 mm and each tooth is separated by a distance of 1 to 2 mm when measured at the base of the tooth; the shell has a cylindrically shaped through hole along at the center of the shell for receiving the core, wherein the core is cylindrically shaped; and the biocarrier has a diameter of 16 to 20 mm and a height of 7 to 9 mm.

In a second aspect, provided herein is a waste treatment system comprising the biocarrier of the first aspect and a waste treatment vessel.

In a first embodiment of the second aspect, provided herein is the waste treatment system of the second aspect, wherein the waste treatment system is a food waste composter, a food waste decomposer, a food waste disposer, or an upflow anaerobic blanket reactor (UASB).

In a second embodiment of the second aspect, provided herein is the waste treatment system of the second aspect, wherein the biocarrier further comprises a biofilm comprising one or more microorganisms selected from the group consisting of Actinobacteria, Lactobacteria, Rhodopseudomonas, Rhodospirillum, Thiobacillus novellus, Alcaligenes, Flavobacterium, Micrococcus, Nitrobacter, Nitosomons, Bifidobacterium, and yeast.

In a third embodiment of the second aspect, provided herein is the waste treatment system of the second embodiment of the second aspect, wherein the waste treatment system is operated at temperature between 20° C. to 80° C.

In a fourth embodiment of the second aspect, provided herein is the waste treatment system of the first embodiment of the second aspect, wherein the waste treatment system is a UASB, wherein the UASB operates at a temperature ranging from 20° C. to 40° C. and a pH from 4 to 8.

In a third aspect, provided herein is a method of reducing the chemical oxygen demand (COD) and the solid content in wastewater, the method comprising the steps of contacting the biocarrier of the first aspect with the wastewater thereby reducing the COD and solid content in the wastewater, wherein the biocarrier further comprises a bacterial biofilm.

In a first embodiment of the third aspect, provided herein is the method of the third aspect, wherein the polymeric material is nylon 6,6; the porous material comprises aluminum silicate or sintered glass; the nylon 6,6 and the aluminum silicate or sintered glass are present in a volumetric ratio of about 1:4 to about 1:5; the outer-surface of the shell is gear-shaped with at least six teeth extending between 3-4 mm from the surface of the shell, wherein each tooth of the gear-shaped shell has a tooth base width of 3 to 4 mm and a tooth face width of 1 to 2 and each tooth is separated by a distance of 1 to 2 mm when measured at the base of the tooth; the shell has a cylindrically shaped through hole along at the center of the shell for receiving the core, wherein the core is cylindrically shaped; and the biocarrier has a diameter of 16 to 20 mm and a height of 7 to 9 mm.

In a fourth aspect, provided herein is a method of preparing the biocarrier of the first aspect, comprising the steps of:
a) providing one or more cores comprising a porous material for attaching microorganisms; and
b) partially enclosing the one or more porous cores by a shell comprising a polymeric material such that the one or more cores are accessible from an external environment, wherein at least one of the one or more cores defines a first axis and opposing surfaces along the first axis, such that the opposing surfaces are exposed to the external environment.

In a first embodiment of the fourth aspect, provided herein is the method of the fourth aspect, wherein the step of partially enclosing the one or more porous cores comprises injection molding or direct insertion of the one or more cores into the polymeric material.

### BRIEF DESCRIPTION OF THE DRAWINGS

The above and other objects and features of the present disclosure will become apparent from the following description of the invention, when taken in conjunction with the accompanying drawings, in which:

FIG. 1 depicts an exemplary biocarrier of the present disclosure having a polymeric shell and a core made of a porous material for attaching microorganisms.

FIG. 2 depicts an exemplary shell of the present disclosure having a plurality of teeth from the outer surface of the shell; and a through hole along at the center of the shell for receiving porous core.

FIG. 3 depicts an exemplary solid cylindrical core made of a porous material of the present disclosure; with opposing surfaces along a first axis and exposed to the external environment; and a lateral surface, which is engaged with the shell.

FIG. 4 depicts an exemplary cylindrical core made of a porous material of the present disclosure; with opposing surfaces along a first axis and exposed to the external environment; a lateral surface, which is engaged with the polymeric shell; and a through hole along the first axis.

FIG. 5 depicts the cross-section of the surface of an exemplary polymeric shell having a plurality of teeth extending from the surface of the polymeric shell, wherein each tooth extends from the outer surface of the shell by distance H; each tooth has a base width of W₁ and a tooth face width W₂; and each tooth is separated by a distance D when measured at the base of the tooth.

FIG. 6(a) depicts an exemplary polymeric shell having a plurality of teeth extending from the surface of the polymer shell in a straight spur gear configuration.

FIG. 6(b) depicts an exemplary polymeric shell having a plurality of teeth extending from the surface of the polymer shell in a double helical/herringbone gear configuration.

FIG. 6(c) depicts an exemplary polymeric shell having a plurality of teeth extending from the surface of the polymer shell in a helical gear configuration.

FIG. 6(d) depicts an exemplary polymeric shell having a plurality of teeth extending from the surface of the polymer shell in a knurled manner.

FIG. 7 depicts an exemplary polymeric shell and a through hole along at the center of the shell for receiving porous core.

FIG. 8 depicts an exemplary polymeric shell, wherein the shell has a plurality of protrusions along its perimeter and a through hole along at the center of the shell for receiving porous core.

FIG. 9 depicts a graph showing the percentage of residual mass remaining in a waste treatment system over time in the presence of the biocarriers described herein having 0, 6, 8, or 10 teeth.

FIG. 10 depicts a bar chart showing the absorbance at 590 nm per unit area of crystal violet stained biofilm on biocarriers made from different materials.

FIG. 11 depicts a graph showing the cumulative weight reduction of a biocarrier made from nylon as compared with a commercial biocarrier made from polypropylene.

FIG. 12A depicts a scanning electron microscopy photo at ×100 magnification. The feature bar measures 100 μm.

FIG. 12B depicts a scanning electron microscopy photo at ×370 magnification. The feature bar measures 50 μm.

FIG. 13 depicts a graph showing the chemical oxygen demand (COD) over time (ppm) of the effluent from a waste treatment system containing polypropylene gear-shaped carrier; a polymeric nylon shell as described herein without a porous core; and a biocarrier described herein containing a polymeric shell and porous core over time.

FIG. 14 depicts a graph showing the COD of effluent from a waste treatment system containing different volume percentages of the biocarrier described herein.

FIG. 15 depicts a graph showing the effect of different volume ratios of commercial polypropylene biocarriers and the biocarriers described herein on the average COD of effluent in a waste treatment system.

FIG. 16 depicts a graph showing the decrease in the residue mass percentage of a UASB system comprising a consortium of bacteria as described herein or sludge.

FIG. 17 depicts an exemplary UASB system comprising a plurality of the biocarriers described herein oriented along the longitudinal axis of the UASB.

### DETAILED DESCRIPTION OF THE INVENTION

In addition to high bacteria loading, the durability of biocarriers that are used in food waste treatment systems with mechanical mixing is also of importance. One major drawback of conventional porous biocarrier materials, such as silicates, are their brittle nature. To overcome this limitation, the biocarriers described herein include an external shell comprising a polymeric material that protects the porous biocarrier materials.

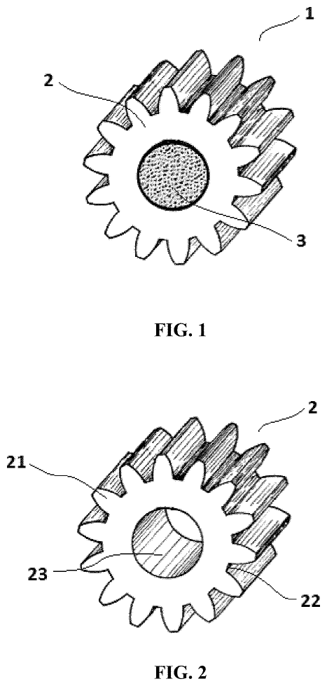

As shown in FIG. 1, the biocarrier 1 of the present disclosure comprises a polymeric shell 2 and one or more porous cores 3 at least partially enclosed within the polymeric shell 2. In certain embodiments, the one or more porous cores 3 are wholly enclosed within the polymeric shell 2 such that the polymeric shell 2 substantially protects the one or more porous cores 3. The terms “enclosed” and “enclosure” used herein do not convey the one or more porous cores 3 are isolated from the external environment by the polymeric shell 2. Rather, as will be apparent from the description below, the polymeric shell 2 allows access to the one or more porous cores 3 such that at least some surface of the one or more porous cores 3 are exposed to the external environment. However, the one or more porous cores 3 are enclosed by the polymeric shell 2 in a sense that the polymeric shell 2 generally defines the contour of a biocarrier, such that when the carrier material is mixed with the food waste, the particles or other solid components of the waste are less likely to impact the one or more porous cores (3) causing its mechanical deterioration.

The shell 2 can comprise any polymeric material known to those of skill in the art that exhibits the requisite durability and porosity. Suitable polymers include, but are not limited to polytetrafluoroethylene (PTFE), acrylonitrile butadiene styrene (ABS), polypropylene (PP), poly(methyl methacrylate) (PMMA), polyethylene (PE), polyvinylchloride (PVC), nylon, or combinations thereof.

In instances in which the polymer material comprises nylon, the nylon can be nylon 6, nylon 6,6, nylon 4,6, nylon 11, nylon 12, nylon 6,9, nylon 6,10 and polyamide blends or copolymers thereof.

The polymeric material can comprise a polymer have an average molecular weight between 1 and 45,000 kDa. In certain embodiments, the average molecular weight of the polymer is between 1 and 40,000; 1 and 35,000; 1 and 30,000; 1 and 25,000; 1 and 20,000; 1 and 15,000; 10 and 10,000; 10 and 9,000; 10 and 8,000; 10 and 7,000; 10 and 6,000; 10 and 5,000; 10 and 4,000; 10 and 3,000; 10 and 2,000; 10 and 1,000; 10 and 900; 10 and 800; 10 and 900; 10 and 700; 10 and 600; 10 and 500; 10 and 400; 10 and 300; 10 and 200; 10 and 100; 10 and 80; 10 and 60; or 10 and 40 kDa.

In certain embodiments, the polymeric material is PTFE having an average molecular weight of 52 to 45,000 kDa, PP having average molecular weight of 4 to 6,000 kDa, PMMA having an average molecular weight of 15 to 340 kDa, PE having an average molecular weight of 4 to 35 kDa, PVC having an average molecular weight of 43 to 233, nylon having an average molecular weight of 10 to 30 kDa, or combinations thereof.

The biocarrier can comprise any number of cores. For example, the biocarier can comprise 1, 2, 3, 4, 5, 6, 7, 8, 9, 10, 11, 12, 13, 14, 15, or more cores. In certain embodiments, the biocarrier comprises 1-15; 1-10; 1-5; 1-4; 1-3; or 1-2. In certain embodiments, the biocarrier has one core.

The one or more cores comprising a porous material can be a high surface area material which offers a large number of niches for microorganisms, such as bacteria and consequently high bacterial loading. The porous material can comprise a ceramic, a silica, sintered glass, a zeolite, diatomaceous earth, activated carbon, bone char, cement, or combinations thereof. In certain embodiments, the porous material is at least one material selected from the group consisting of diatomaceous earth, sintered glass, an aluminum silicate, such as kaolinite, and a calcium silicate, such as wollastonite.

In certain embodiments, the porous material is at least one silica selected from the group consisting of nesosilicates, sorosilicates, cyclosilicates, inosilicates, phyllosilicates, tectosilicates. In certain embodiments, the silica based material comprises at least one cation selected from the group consisting of sodium, lithium, magnesium, calcium, aluminum, iron, zirconium, and manganese.

In certain embodiments, the silica comprises an aluminum silicate. In certain embodiments, the aluminum silicate is Al₂SiO₅ (Al₂O₃SiO₂), such as andalusite, kyanite and sillimanite; Al₂Si₂O₅(OH)₄ (Al₂O₃.2SiO₂.2H₂O), such as kaolinite, Al₂Si₂O₇(Al₂O₃.2SiO₂), such as metakaolinite, or combinations thereof.

In certain embodiments, the porous material comprises a silica having Al₂O₃ and SiO₂ in a ratio of about 1:1.5 to about 1:2.5; about 1:1.75 to about 1:2.25; or about 1:1.9 to about 1:2.1 by mass. In certain embodiments, the silica material comprises an aluminum silicate having Al₂O₃ and SiO₂ in a ratio of about 1:2 by mass.

In certain embodiments, the porous material comprises a silica selected from kaolinite activated silica and calcium silicate wollastonite; or diatomaceous earth, and combinations thereof.

In certain embodiments, the porous material is sintered glass.

The surface area of the porous material can be about 1,000 to about 3,000 m²/L. In certain embodiments, the surface area of the porous material is about 1,000 to about 2,000; about 1,000 to about 2,000; about bout 1,500 to about 2,000; or about 1,500 to about 1,800 m²/L.

In instances where the porous material comprises calcium silicate wollastonite, the surface area of the porous material can be about 100 to about 950 m²/L. In certain embodiments, the surface area of the calcium silicate wollastonite is about 130; about 400, about 520, or about 920 m²/L.

In instances where the porous material comprises kaolinite activated silica, the surface area of the porous material can be about 100 to about 900 m²/L. In certain embodiments, the surface area of the kaolinite activated silica is about 600; about 1,430, about 1,620 m²/L.

In instances where the porous material is sintered glass, the sintered glas can have a surface area of about 200 to about 300 m²/L. In certain embodiments, the sintered glass has a surface area of about 250 to about 300 m²/L; 250 to about 290 m²/L; 250 to about 280 m²/L; or 260 to about 280 m²/L. In certain embodiments, the sintered glass has a surface area of about 270 m²/L.

The porous material provides numerous pores, which act as micro-niches for microoranisms to colonize and grow. Accordingly, at least a portion of the pores in the porous material can be large enough to accommodate one or more different types of microorganisms, such as a bacteria or fungi. In certain embodiments, the porous material comprises pores that have an average diameter of about 0.1 to about 100 μm; about 0.1 to about 90 μm; about 0.1 to about 80 μm; about 0.1 to about 70 μm; about 0.1 to about 60 μm; about 0.1 to about 50 μm; about 0.1 to about 40 μm; about 0.1 to about 30 μm; about 0.1 to about 20 μm; about 0.1 to about 10 μm; about 1 to about 10 μm and combinations thereof.

In instances where the porous material comprises calcium silicate wollastonite, the average pore size is about 0.1 μm to about 10 μm.

In instances where the porous material comprises kaolinite activated silica, the average pore size is about 0.05 μm to about 8 μm.

In instances where the porous material comprises sintered glass, the average pore size is 0.1 μm to about 300 μm or about 30 μm to about 300 μm.

The optimal shape and dimensions of the polymeric shell 2 is based, in part, on the intended application and type of waste treatment system (including, e.g., the volume of the waste treatment machine chamber, the type of mixing, the amount of biocarriers required for the particular application, etc) that the biocarrier 1 will be used in. The selection of the optimal shape and dimension of the polymeric shell 2 is well within the skill of a person of ordinary skill in the art haven taken into consideration the teachings and data provided herein.

For the sake of simplicity the polymeric shell 2 are generally depicted as a cylinder with or without protrusions and/or teeth 21 extending from its circumferential surface 22 as shown in FIGS. 7 and 2, however the polymeric shell 2 can be any shape including, but not limited to, cubes, cuboids, spheres, ellipsoids, cylinders, cones, triangular prisms, hexagonal prisms, triangular base pyramids, square-based pyramids, hexagonal pyramids, tetrahedrons, and polyhedrons, such as octahedrons, dodecahedrons, and icosahedrons. The polymeric shell 2 can further be an irregular shape.

In the examples below, the polymeric shell 2 is cylindrically shaped. The largest diametrical dimension (including any protrusions and/or teeth 21 on the polymeric shell 2) of the polymeric shell 2 can be about 5 mm to about 50 mm. In certain embodiments, the largest diametrical dimension of the polymeric shell 2 is about 5 mm to about 40 mm; about 5 mm to about 30 mm; or about 5 mm to about 20 mm. In certain embodiments, the largest diametrical dimension of the polymeric shell 2 is about 10 mm to about 20 mm. In certain embodiments, the largest diametrical dimension of the polymeric shell 2 is about 6.5 mm, about 11 mm, about 12 mm, or about 18 mm.

The height of the polymeric shell 2 can be about 5 mm to about 10 mm. In certain embodiments, the height of the polymeric shell 2 is about 6 to about 9 mm; about 7 mm to about 9 mm; or about 8 mm to about 9 mm.

The shape and dimension of the one or more porous cores 3 is based, in part, on the intended application; type of waste treatment system (including, e.g., the volume of the waste treatment machine chamber, the type of mixing, the amount of biocarriers required for the particular application, etc) that the biocarrier 1 will be used in; and the shape and dimension of the polymeric shell 2. The selection of the optimal shape and dimension of the one or more porous cores 3 is well within the skill of a person of ordinary skill in the art haven taken into consideration the teachings and data provided herein.

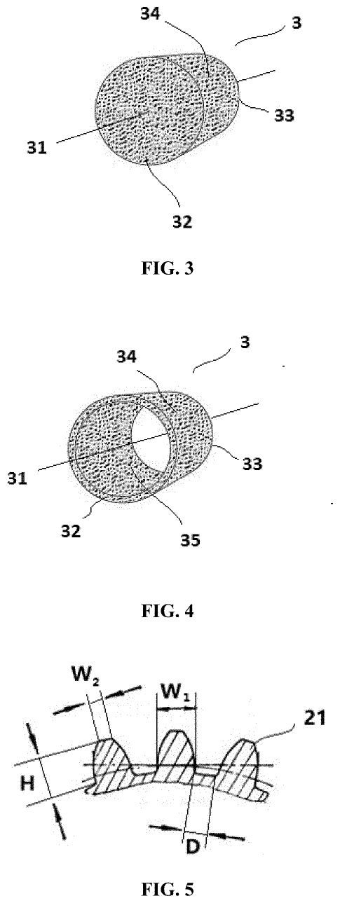

For the sake of simplicity the porous core 3 is generally depicted as a solid cylinder as shown in FIG. 3 or a cylinder with a through hole as shown in FIG. 4 herein, however the porous core 3 can be any shape including, but not limited to, cubes, cuboids, spheres, ellipsoids, cylinders, cones, triangular prisms, hexagonal prisms, triangular base pyramids, square-based pyramids, hexagonal pyramids, tetrahedrons, and polyhedrons, such as octahedrons, dodecahedrons, and icosahedrons. The porous core 3 can further be an irregular shape.

In the examples below, the porous core 3 is cylindrically shaped. The diametrical dimension of the porous core 3 is smaller than the diametrical dimension of the polymeric shell 2 and can be about 3 mm to about 20 mm. In certain embodiments, the diametrical dimension of the porous core 3 is about 3 mm to about 15 mm; about 3 mm to about 10 mm; about 5 mm to about 10 mm; about 7 mm to about 10 mm; or about 7 mm to about 9 mm. In certain embodiments, the diametrical dimension of the porous core 3 is about 8 mm.

The polymeric shell 2 is intended to protect the porous core 3 from collision with, e.g., other biocarriers and/or the interior surface(s) of the waste water treatment system. Accordingly, it is generally preferable for the height of the polymer shell 2 to be larger than the height of the porous core 3 to provide protection to the porous core 3. The height of the porous core 3 can be about 5 mm to about 10 mm. In certain embodiments, the height of the porous core 3 is about 5 to about 9 mm; about 5 mm to about 8 mm; about 5 mm to about 7 mm; or about 6 mm to about 7 mm. In certain embodiments, the height of the porous core 3 is about 6.4 mm.

In certain embodiments, the porous core 3 is a porous solid cylinder made of continuous porous material as shown in FIG. 3. The cylinder has opposing end surfaces 32, 33 along a first axis 31 and a lateral surface 34 around the first axis. In certain embodiments, the porous core 3 is a porous cylinder having a through hole 35 therein as shown in FIG. 4. The through hole 35 extends generally along the first axis 31 of the cylinder. Likewise, the porous core 3 with a through hole 35 defines opposing end surfaces 32, 33 along the first axis 31 and a lateral surface 34 around the first axis. Advantageously, the through hole 31 can increase the surface-to-volume ratio as well as the circulation of waste water through the porous core improving contact and contact time with the biofilm on residing on and within the porous core 3. Where the porous core 3 is formed as other shapes, whether with or without one or more through holes, it may likewise be described as having opposing end surfaces along a first axis and a lateral surface around the first axis. The one or more through holes may extend along or at an angle to the first axis from one of the opposing surfaces to the other of the opposing surfaces. Means other than through holes are also possible and within the contemplation of the present disclosure to increase the surface-to-volume ratio of the porous core 3.

The polymeric shell 2 can include a plurality of protrusions 24 along its perimeter as shown in FIG. 2. Any number of protrusions 24 can be present on the polymeric shell 2, such as from about 5 to about 50 protrusions 24. The protrusions 24 are depicted as circles in FIG. 8 for the sake of simplicity, but can be any three dimensional structures, such as cubes, cuboids, spheres, ellipsoids, cylinders, cones, triangular prisms, hexagonal prisms, triangular base pyramids, square-based pyramids, hexagonal pyramids, tetrahedrons, polyhedrons, such as octahedrons, dodecahedrons, and icosahedrons, and irregular shapes. The protrusions 24 can be arranged in an ordered regular fashion, can be placed randomly, or combinations thereof.

In certain embodiments, the polymeric shell 2 is gear-shaped having a plurality of teeth 21 extending from the outer surface 22 of the shell 2 along its perimeter as shown in FIG. 2. The polymeric shell 2 can comprise 4 or more teeth. In certain embodiments, the polymeric shell comprises about 4 to about 20 teeth; about 4 to about 18 teeth; about 4 to about 16 teeth; about 4 to about 14 teeth; about 4 to about 12 teeth; about 5 to about 12 teeth; about 5 to about 11 teeth; about 5 to about 10 teeth; or about 6 to about 10 teeth.

FIG. 5 shows a cross-section of some teeth 21 of a gear-shaped shell 2. The teeth 21 can extend from the surface 22 of the shell 2 by a distance (H) of about 3 to about 4 mm. In certain embodiments, the teeth 21 are extended from the surface 22 of the shell 2 by a distance about 3 to about 4 mm; 3 to about 3.8 mm; 3 to about 3.6 mm; or 3.1 to about 3.4 mm. In certain embodiments, the teeth 21 are extended from the surface 22 of the shell 2 by a distance (H) about 3.3 mm.

Each tooth 21 of the gear-shaped shell 2 can have a tooth base width (W₁) of about 3 to about 4 mm. In certain embodiments, the tooth base width (W₁) is about 3 to about 4 mm; 3.2 to about 4 mm; 3.4 to about 4 mm; or 3.4 to about 3.8 mm. In certain embodiments, the tooth base width (W₁) is about 3.6 mm.

Each tooth 21 of the gear-shaped shell 2 can have a tooth face width (W₂) of about 1 to about 2 mm. In certain embodiments, the tooth face width (W₂) is about 1 to about 2 mm; 1.2 to about 2 mm; 1.2 to about 1.8 mm; 1.4 to about 1.8 mm; or 1.4 to about 1.6 mm. In certain embodiments, the tooth face width (W₂) is about 1.5 mm.

Each tooth 21 of the gear-shaped shell 2 can be separated by a distance (D) of about 1 to about 2 mm. In certain embodiments, the distance (D) is about 1 to about 1.5 mm or about 1.5 to about 2 mm.

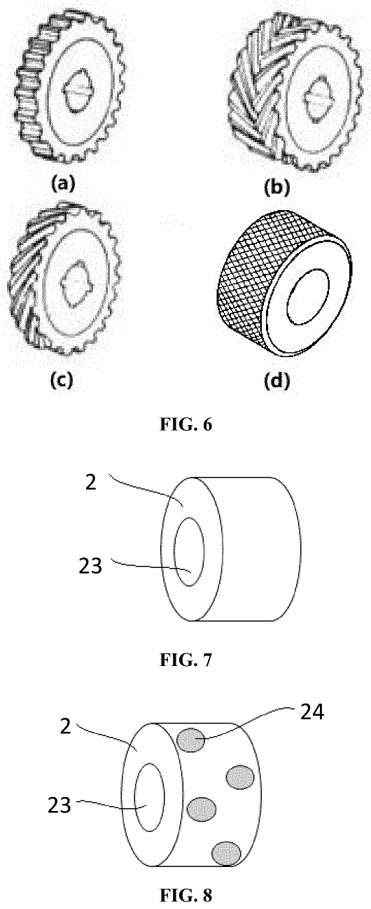

As shown in FIGS. 6(a) to 6(c), the polymeric shell 2 can have a plurality of teeth 21 extending from the surface 22 of the polymer shell 2 in a straight spur gear configuration, helical spur gear configuration or double helical gear configuration and combinations thereof. As shown in FIG. 6(d), the polymeric shell 2 can have a plurality of teeth 21 extending from the surface 22 of the polymer shell 2 in a knurled manner.

Despite terms such as gears and teeth are used, it is not intended that the shell 2 must take an exact gear shape in a mechanics sense. Rather, minor variations to the contour are possible. For instance, the tooth can have a trapezoidal, triangular, or tubular cross-section.

The polymeric shell 2 defines an inner space 23 for receiving the one or more porous cores 3. In certain embodiments, the inner space 23 comprises one or more through holes. Each through hole is configured for receiving a respective porous core 3, such that when a porous core 3 is fitted therein, the lateral surface 34 of the porous core 3 engages the inner surface of the through hole and the opposing surfaces 32, 33 of the porous core 3 are exposed to the external environment. Where the polymeric shell 2 is gear-shaped, it can have a cylindrically shaped through hole at or near the center of the gear for receiving a porous core 3.

In certain embodiments, the biocarriers further comprise a biofilm comprising one or more microorganisms selected from the group consisting of bacteria and fungi. In certain embodiments the bacteria can be selected from Actinobacteria, Bacillus, such as Bacillus licheniformis and Bacillus subtilis Lactobacteria, Rhodopseudomonas, Rhodospirillum, Thiobacillus novellus, Alcaligenes, Flavobacterium, Micrococcus, Nitrobacter, Nitosomons, Bifidobacterium, and combinations thereof. In certain embodiments, the fungi can be yeast. In certain embodiments, the biofilm can further comprise enzymes, such as amylases, lipase, cellulases, proteases, and combinations thereof.

Also provided herein, is a waste treatment system comprising a biocarrier as described herein and a waste treatment vessel. The waste treatment vessel can be a food waste composter, a food waste decomposer, a food waste disposer, food waste digester, a food waste fermenter, aerobic bioreactor, integrated anaerobic-aerobic bioreactor, or an upflow anaerobic blanket reactor (UASB). The waste treatment system can be an industrial waste treatment system or a consumer waste treatment system.

As will be apparent to the ordinary skilled artisan in view of this disclosure, the biocarrier, systems, and methods described herein can be applied for treatment of wastes that include, but are not limited to: brewery, distillery, winery, pharmaceutical, cannery, cheese processing, potato processing, pulp and paper, yeast production, dairy, starch processing, pet food production, oil processing, beverage, sauce making, and other processed food making industry, tanning, coking wastewater, and food waste treatment effluent.

In certain embodiments, the waste treatment system is operated at a temperature between about 20° C. to about 80° C. In certain embodiments, the waste treatment system is operated at a temperature between about 20° C. to about 70° C.; about 20° C. to about 60° C.; about 20° C. to about 50° C.; about 20° C. to about 40° C.; or about 20° C. to about 30° C.

In certain embodiments, the waste treatment system is operated at a pH of about 4 to about 8.

Also provided herein is a method of reducing the chemical oxygen demand (COD) and the solid content in wastewater, the method comprising the steps of contacting the biocarrier as described herein with the wastewater thereby reducing the COD and solid content in the wastewater, wherein the biocarrier further comprises a bacterial biofilm.

### Example 1

The smaller size of the food waste can favor the degradation of the food waste due to the increased surface area to volume ratio. Unlike commercial biocarriers, which are commonly in spherical or cylindrical shape, a gear shape biocarrier helps to breakdown the food waste into smaller pieces, which can reduce the time required to treat the waste.

In the present example, an experiment comparing the number of teeth in the biocarrier for the food waste cracking ability was carried out. Biocarriers with 4 different numbers of teeth (0 teeth, 6 teeth, 8 teeth, and 10 teeth) were compared.

The test was carried out in a household food waste treatment machine (max. capacity of 1 kg food waste) in which the exit was at the bottom as a sieve with 2 mm openings. 500 g of simulated food waste (composition as listed in Table 1) was put into the machine together with the biocarriers. During mixing, the biocarriers rotated to break the food waste into small pieces. If the food waste pieces were smaller than 2 mm, it would escape from the machine and yielded a mass reduction of the food waste inside the machine. The residual mass in the machine at different time intervals was recorded. After 24 hours of operation, an additional 500 g of food waste was added to the machine and the residual mass over time was recorded. The experiment was carried out three times for each type of biocarrier.

TABLE 1
Composition of the simulated food waste

| Component | Mass Percentage (% w/w) |
|---|---|
| Rice | 18 |
| Bread | 18 |
| Vegetable | 28 |
| Pork | 25 |
| Eggs | 7 |
| Corn oil | 3.5 |
| Table salt | 0.5 |

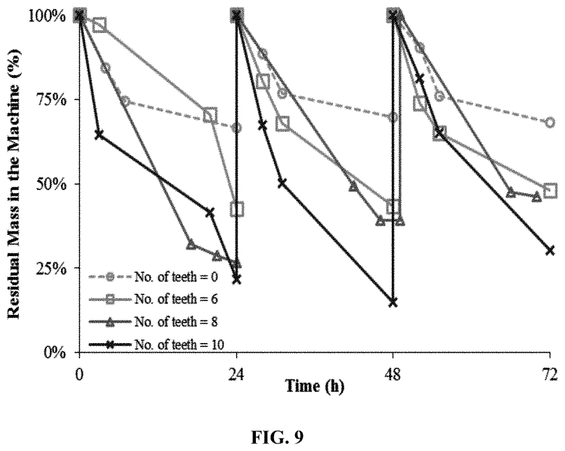

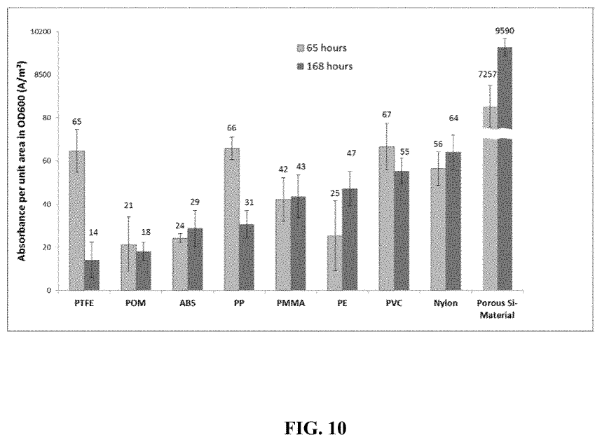

The percentage of the residual mass in the food waste treatment machine over time is shown in FIG. 9. The residual mass in the food waste treatment machine rapidly decreased over the first 3-4 hours. However, the rate of residual mass reduction decreased after the 3-4 hour mark.

The average mass reduction of food waste using biocarriers with different numbers of teeth is summarized in Table 2. These results demonstrate that the gear shape and number of gear teeth have an impact on the biocarrier's ability to reduce the mass of the food waste for degradation. The biocarrier with 10 teeth achieved the greatest mass reduction. 6 teeth in the biocarriers achieved a 55% mass reduction in 24 hours (the general operating duration for commercial food waste treatment machine).

TABLE 2
The residual mass in the food waste
treatment machine after each cycle

| No. of Teeth in | Average Mass Reduction |
|---|---|
| Biocarrier | after 24 h (%) |
| 0 teeth | 32% ± 2% |
| 6 teeth | 55% ± 3% |
| 8 teeth | 63% ± 10% |
| 10 teeth | 78% ± 8% |

### Example 2

In this example, the amount of the microbial biofilm attached on the biocarriers prepared from different materials was compared. Nylon, polyvinyl chloride, polytetrafluoroethylene, polyoxymethylene, acrylonitrile butadiene styrene, poly(methyl methacrylate), and sintered glass (Sera Siporax® and having a surface area of about 270 m²/L) examined.

The tested microorganisms were a mixture of bacteria, fungi, and enzymes used for food waste treatment. Bacteria included Actinobacteria, Lactobacteria, Rhodopseudomonas spp., Rhodospirillum spp., Thiobacillus novellus, Alcaligenes spp. such as Alcaligenes denitrificans etc., Flavobacterium spp. such as Flavobacterium aquatile and Flavobacterium oceanosedimentum etc., Micrococcus spp. such as Micrococcus luteus and Micrococcus roseus etc., Nitrobacter spp. such as Nitrobacter Winogradskyi etc. and Nitosomons spp. such as Nitosomons curopae, and Bifidobacterium spp. etc. Fungi included yeast etc. while enzymes included amylase, lipase, cellulase, and protease etc.

The quantification of the biofilm on the material surface was carried out according to the procedure described by Judith H. Merritt et al., Growing and Analyzing Static Biofilms. Curr Protoc Microbiol. 2005 July; Chapter 1: Unit 1B.1, in which the biofilm was stained using crystal violet and the absorbance of the stained biofilm was measured at 590 nm. The amount of the biofilm was normalized and was presented in terms of the absorbance at 590 nm per unit bulk surface area in m².

FIG. 10 summarizes the results of the biofilm formation on biocarriers prepared from different materials. The results demonstrate that all the materials (both the polymeric materials and the porous Si-material) can support the biofilm growth onto the surface. The amount of the biofilm was also compared at 65 h and 168 h to see if there would be changes in the amount of biofilm during a prolonged period of cultivation to simulate the long operating duration in a food waste treatment system. Among the examined polymeric materials, nylon was observed to have the highest amount of biofilm per unit surface area for cultivation for 168 h, and was higher than the commercial biocarriers, which are generally made of polyethylene and polypropylene. However, the porous Si-based materials provided a much higher amount of biofilm. These results demonstrated that porous Si-based materials can be used to significantly increase the microbial loading biocarriers.

### Example 3

In this example, the durability of a commercial polypropylene carrier, a porous biocarrier without external shell, and a biocarrier as described herein having a polymeric shell partially covering a porous core were compared.

The durability of each biocarrier was studied by placing the biocarrier in a vibrating bowl, which induced frequent collisions between the biocarriers, mimicking conditions in waste treatment systems. The loss in weight of the bioccariers was measured at different time intervals.

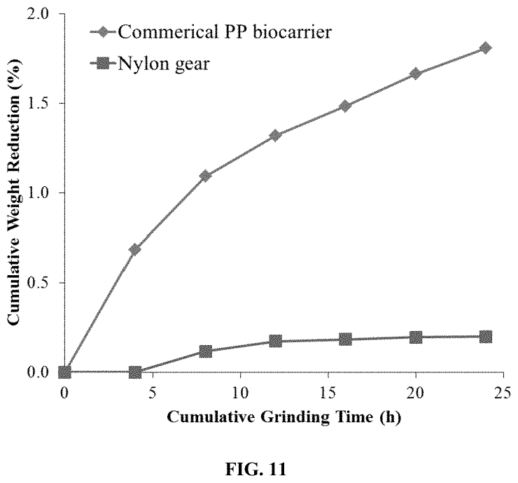

FIG. 11 shows that the nylon gear experienced a smaller cumulative weight loss during grinding than the commercial PP biocarrier. In other words, the external nylon gear shell had a greater resistance in wearing/abrasion than the commercial PP biocarrier.

When an external nylon shell was used to cover the porous core, its weight loss was reduced more than fifteen-fold compared with the uncovered porous Si-based material and comparable to commercial PP biocarriers (Table 3). Thus, covering the outside of the porous core material with a polymeric shell, such as nylon, enhances the wearing/abrasion resisting ability of the resulting biocarrier.

TABLE 3
The comparison of the mass reduction after grinding for 4 hours

| | Weight loss after grinding for 4 h |
|---|---|
| Biocarrier materials | (%) |
| Commercial PP biocarrier | 0.69% |
| Porous Si-based material | 16.24% |
| External nylon gear shell + | 1.08% |
| Porous Si-based material | |

### Example 4

In this example, the microbial loading of nylon covered porous Si-based material biocarriers were compared with commercial PP biocarriers, and porous Si-based material biocarriers.

The volumetric ratio of the porous Si-based material to the nylon external shell was about 1:4.56.

Two cylindrically shaped Si-based porous material biocarriers (porous material #1 and porous material #2) having a specific area ranging from 810 m²/L to 1,620 m²/L were used. Properties of porous materials #1 and #2 are shown in Table 4 below.

TABLE 4
Selected properties of porous materials #1 and #2

| Property | Porous Material #1 | Porous Material #2 |
|---|---|---|
| Surface | 1,060 m²/L | 1,620 m²/L |
| area | | |
| Diameter | OD: 12.22 mm | 7.99 mm |
| | ID: 4.53 mm | |
| Height | 11.72 mm | 6.40 mm |
| Pore size | ~150-200 μm | 0.1-1,000 μm |
| Bulk | 1.18 cm³ | 0.32 cm³ |
| volume | | |
| Bulk | 8.18 cm² | 2.61 cm² |
| area | | |
| Raw | Diatomaceous earth | Kaolinite |
| material | | |

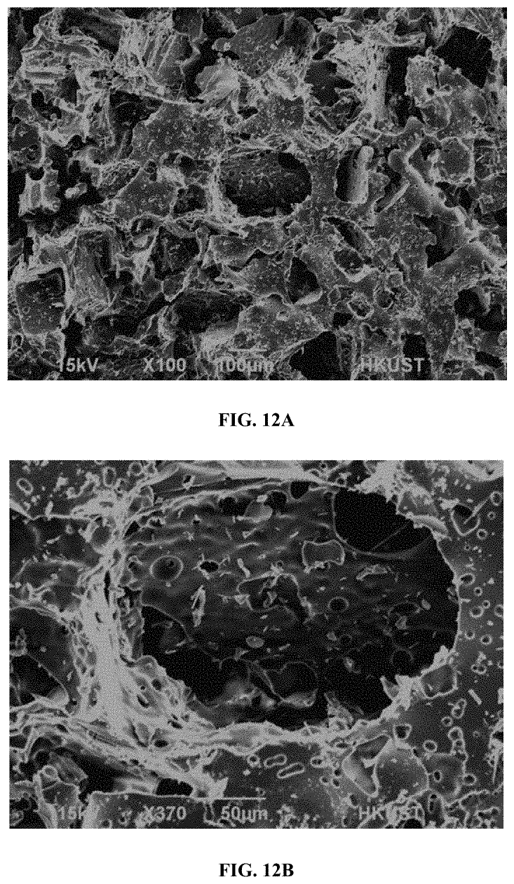

The microscopic morphology of the porous core in FIGS. 12A and 12B reveals its internal pore structure. The method for quantifying the amount of biofilm produced on the biocarriers was the same as that in Example 2. The results are summarized in Table 5. The results are presented in terms of the absorbance at 590 nm per unit bulk area in m².

Table 5 shows that the porous materials had a remarkably high microbial loading. After introducing the external shell to the porous material, the microbial loading was reduced, but it was still at least 35 times greater than the commercial PP biocarrier.

TABLE 5
Microbial loading of different biocarriers

| | | OD590 per unit bulk area after 65 h |
|---|---|---|
| Biocarrier materials | | incubation (A/m²) |
| Commercial PP biocarrier | | 66 |
| Porous material #1 | | 4,480 |
| Porous material #2 | | 3,550 |
| Nylon external | + Porous material | 2,520 |
| shell | #1 | |
| | + Porous material | 2,520 |
| | #2 | |

### Example 5

In this example, verification tests were carried out to verify the food waste treatment performance of the developed biocarriers in a food waste treatment system compared with the commercial PP biocarriers in gear shape. The same volume of the biocarrier which had been pre-inoculated with food waste treating microbes and 500 g of food waste were added to the food waste treatment system and the chemical oxygen demand (COD) reduction of the wastewater exiting from the machine were measured at different time intervals during the test. For each group, four cycles (24 hours for each cycle) were carried out.

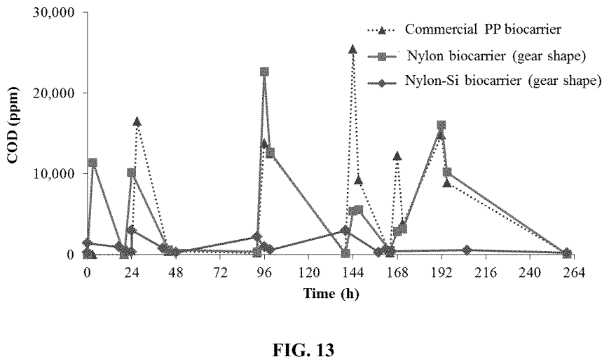

FIG. 13 shows the COD concentration in the wastewater exited from the system. The COD in the wastewater was fluctuated at a high concentration for commercial PP biocarrier. In contrast, by using Nylon-Si biocarrier, the COD in the wastewater was significantly reduced and importantly the COD of the waste water was relatively stable; and this effective microbial action was also reflected by a reduction of malodor during its operation.

### Example 6

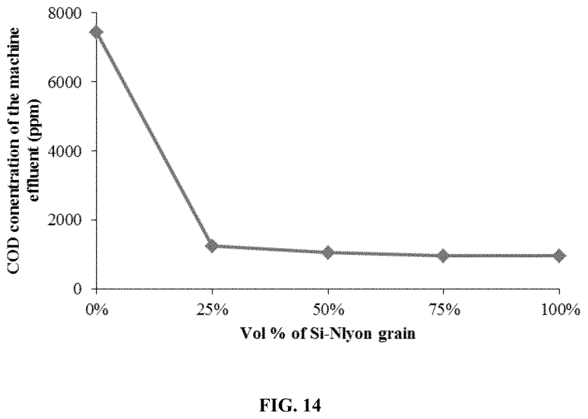

In this example, the effect of varying the volume percentage of the Nylon-Si biocarrier utilized on the COD of the effluent from a food waste treatment system was investigated. Different volume ratios of the Nylon-Si biocarrier of 100% Nylon-Si biocarrier, 75% Nylon-Si biocarrier: 25% commercial PP biocarrier, 50% Nylon-Si biocarrier:50% commercial PP biocarrier, 25% Nylon-Si biocarrier:75% commercial PP biocarrier, and 100% commercial PP biocarrier were tested. The experimental procedure was similar to the procedure described in EXAMPLE 5. The results are summarized in FIG. 14, which indicates that the addition of 25 vol % of the Nylon-Si biocarrier to the waste treatment system is sufficient to achieve a significant reduction of the COD in the wastewater.

### Example 7

The example aims to demonstrate the effect of replacing different portions of commercially available polypropylene based biocarriers in a food waste treatment system with the biocarriers described herein, which are detailed as shown in the below table.

| | Volumetric ratio | |
|---|---|---|
| | | Commercial |
| | Nylon-Si | PP |
| | Biocarrier | biocarrier |
| 100% Nylon-Si biocarrier | 100% | 0% |
| 75% Nylon-Si biocarrier: 25% commercial | 75% | 25% |
| PP biocarrier | | |
| 50% Nylon-Si biocarrier: 50% commercial | 50% | 50% |
| PP biocarrier | | |
| 25% Nylon-Si biocarrier: 75% commercial | 25% | 75% |
| PP biocarrier | | |
| 100% commercial PP biocarrier | 0% | 100% |

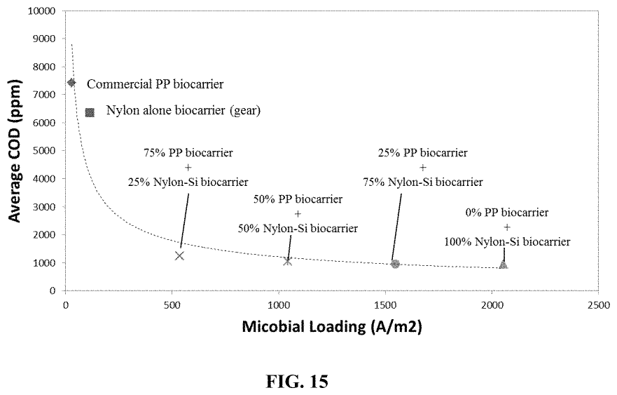

FIG. 15 depicts a graph showing the COD of the mixed biocarrier systems described in the proceeding table. When 25% of the commercial polypropylene biocarriers are replaced with the biocarriers described herein, an almost tenfold decrease in average COD of the effluent is observed. Further gradual reductions are achieved by replacing larger portions of the conventional polypropylene biocarriers. Advantageously, the greatest benefit in COD reduction occurs when only 25% of the commercially available polypropylene biocarriers are replaced. This provides an economical way of enhancing the performance of waste water treatment systems.

### Example 8

The Nylon-Si biocarriers can be prepared by direct insertion of a porous Si-based material into a nylon external gear shell or by conventional injection molding.

For direct insertion, the porous Si-based material is inserted into the nylon gear with a hole in the middle manually or by using a machine, such as punching machine, stamping press, hydraulic press, etc.

For conventional injection molding process, the porous Si-based material is first placed into the mold followed by injecting melted nylon into the mold to form the biocarrier after cooling and demolding. The key operating parameters include the temperature and the compressive pressure. The porous material can withstand a temperature above the melting point of nylon, so the usual operating temperature for nylon molding will be fine, which is about 250° C. or higher. Since the porous material is brittle, the compressive pressure during the molding process should be lower than the lowest compressive strength (generally around 10 MPa or lower) of the porous material.

### Example 9

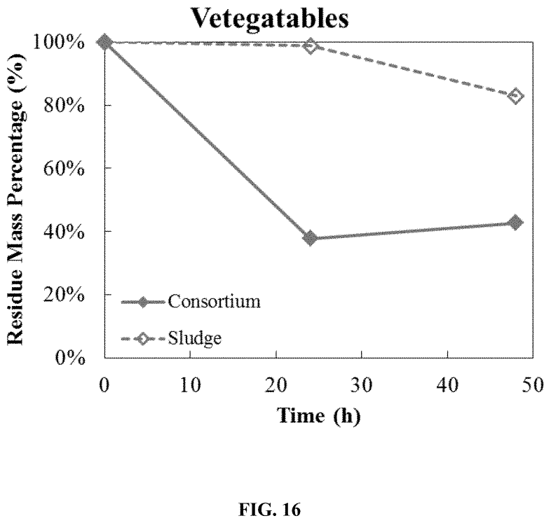

Other than treating the COD in the wastewater from the food waste treatment, the microbes can also be used for treating food waste solid and its waste water content using a UASB. In the present example, an experiment comparing the solid content reduction of granular sludge used in a UASB reactor and a mixture of food waste treating microbes was performed. 10 g of granular sludge and 5 mL of the microbes were added to individual food wastes such as vegetables. The amount of the food waste added is summarized below. The net dry mass change (excluding the mass of the sludge and the microbes) was measured at certain time intervals. The results are shown in FIG. 16 The results indicate that the granular sludge did not show a significant reduction of food waste; more than 80% of the solid content was still remaining after 48 hours while the microbes showed more than 50% solid reduction of the vegetable waste, which was similar to a conventional digester (40-60% reduction of the total solid).

| | Amount of addition (g as dry mass) |
|---|---|
| Granular sludge (10 g) | 0.634 |
| Commercial bacteria (5 mL) | 0.870 |

### Example 10

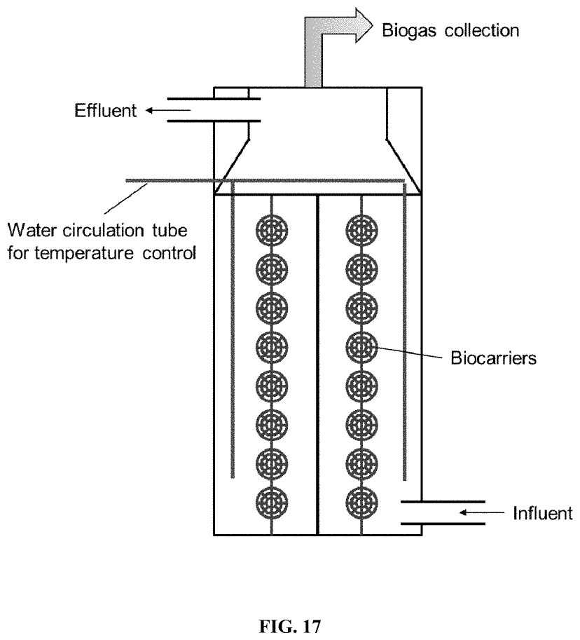

In the present example, the application of the high microbial loading biocarrier in a UASB reactor for treating food waste wastewater is demonstrated. The reactor was designed to treat food waste wastewater with COD ranging from 2,000 ppm to 40,000 ppm (average=16,556 ppm) and pH value ranging from 4.5-6.0, with an organic loading is to up to 10 kg COD/m³/d. The schematic of the pilot scale reactor is illustrated in FIG. 17. The reactor can be made of polyvinyl chloride with a working volume of 5 tons. The biocarriers are fixed inside the reactor to enhance the microbial loading. During degradation, methane gas is generated and is collected at the top of the reactor. The reactor is operated at moderate temperature (˜35° C.) which is provided by a temperate water circulation tube. The average COD of the effluent is expected to be no more than 600 ppm for later aerobic treatment, which is equivalent to an average COD removal of greater than 96%. This example illustrated that a UASB reactor equipped with the biocarriers can exert more than 90% of the COD removal for the high COD food waste related wastewater.

It is to be understood that the methods described herein are not limited to the particular methodology and protocols, described herein and as such can vary. It is also to be understood that the terminology used herein is for the purpose of describing particular embodiments only, and is not intended to limit the scope of the methods, systems, and compositions described herein, which will be limited only by the appended claims. While some embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein can be employed in practicing the disclosure. It is intended that the following claims define the scope of the disclosure and that biocarriers, methods, systems, and compositions within the scope of these claims and their equivalents be covered thereby.

Several aspects are described with reference to example applications for illustration. Unless otherwise indicated, any embodiment can be combined with any other embodiment. It should be understood that numerous specific details, relationships, and methods are set forth to provide a full understanding of the features described herein. A skilled artisan, however, will readily recognize that the features described herein can be practiced without one or more of the specific details or with other methods. The features described herein are not limited by the illustrated ordering of acts or events, as some acts can occur in different orders and/or concurrently with other acts or events. Furthermore, not all illustrated acts or events are required to implement a methodology in accordance with the features described herein.

While some embodiments have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention.

Furthermore, it shall be understood that all aspects of the invention are not limited to the specific depictions, configurations or relative proportions set forth herein which depend upon a variety of conditions and variables. It should be understood that various alternatives to the embodiments of the invention described herein can be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby. All patents, patent applications, publications, and descriptions mentioned herein are incorporated by reference in their entirety for all purposes. None is admitted to be prior art.

What is claimed is:

1. A biocarrier comprising:
a shell comprising a polymeric material; and
one or more cores comprising a porous material for attaching microorganisms, wherein the one or more cores are at least partially enclosed by the shell such that the one or more cores are accessible from an external environment,
wherein at least one of the one or more cores defines a first axis and opposing surfaces along the first axis, such that the opposing surfaces are exposed to the external environment.

2. The biocarrier of claim 1, wherein at least one of the one or more cores is a continuous porous material or has a through hole along the first axis.

3. The biocarrier of claim 1, wherein the core is a cylinder configured longitudinally along the first axis; having opposing end surfaces exposed to the external environment; and a lateral surface.

4. The biocarrier of claim 3, wherein the core is engaged with the shell via the lateral surface of the core.

5. The biocarrier of claim 1, wherein the shell has a plurality of protrusions along its perimeter and one or more through holes for receiving the one or more cores.

6. The biocarrier of claim 1, wherein the shell is gear-shaped with a plurality of teeth extending from an outer surface of the shell and the shell has a cylindrically shaped through hole at the center of the shell for receiving the core, wherein the core is cylindrically shaped.

7. The biocarrier of claim 6, wherein the shell comprises four or more teeth.

8. The biocarrier of claim 7, wherein each tooth of the gear-shaped shell extends from the outer surface of the shell by 3 to 4 mm.

9. The biocarrier of claim 6, wherein each tooth of the gear-shaped shell has a tooth base width of 3 to 4 mm and a tooth face width of 1 to 2 mm.

10. The biocarrier of claim 9, wherein each tooth is separated by a distance of 1 to 2 mm when measured at the base of the tooth.

11. The biocarrier of claim 1, wherein the polymeric material is polytetrafluoroethylene (PTFE), acrylonitrile butadiene styrene (ABS), polypropylene (PP), poly(methyl methacrylate) (PMMA), polyethylene (PE), polyvinylchloride (PVC), nylon, or a combination thereof.

12. The biocarrier of claim 1, wherein the porous material comprises a ceramic, a silica, sintered glass, zeolite, diatomaceous earth, activated carbon, bone char, cement, or combinations thereof.

13. The biocarrier of claim 1, wherein the polymeric material is nylon 6,6; the porous material comprises aluminum silicate or sintered glass; the nylon 6,6 and the aluminum silicate or sintered glass are present in a volumetric ratio of about 1:4 to about 1:5; the outer-surface of the shell is gear-shaped with at least six teeth extending between 3-4 mm from the surface of the shell, wherein each tooth of the gear-shaped shell has a tooth base width of 3 to 4 mm and a tooth face width of 1 to 2 mm and each tooth is separated by a distance of 1 to 2 mm when measured at the base of the tooth; the shell has a cylindrically shaped through hole along at the center of the shell for receiving the core, wherein the core is cylindrically shaped; and the biocarrier has a diameter of 16 to 20 mm and a height of 7 to 9 mm.

14. A waste treatment system comprising the biocarrier of claim 1 and a waste treatment vessel.

15. The waste treatment system of claim 14, wherein the waste treatment system is a food waste composter, a food waste decomposer, a food waste disposer, or an upflow anaerobic blanket reactor (UASB).

16. The waste treatment system of claim 14, wherein the biocarrier further comprises a biofilm comprising one or more microorganisms selected from the group consisting of Actinobacteria, Lactobacteria, Rhodopseudomonas, Rhodospirillum, Thiobacillus novellus, Alcaligenes, Flavobacterium, Micrococcus, Nitrobacter, Nitosomons, Bifidobacterium, and yeast.

17. The waste treatment system claim 16, wherein the waste treatment system is operated at temperature between 20° C. to 80° C.

18. The waste treatment system of claim 15, wherein the waste treatment system is a UASB, wherein the UASB operates at a temperature ranging from 20° C. to 40° C. and a pH from 4 to 8.

19. A method of reducing the chemical oxygen demand (COD) and the solid content in wastewater, the method comprising the steps of contacting the biocarrier of claim 1 with the wastewater thereby reducing the COD and solid content in the wastewater, wherein the biocarrier further comprises a bacterial biofilm.

20. The method of claim 19, wherein the polymeric material is nylon 6,6; the porous material comprises aluminum silicate or sintered glass; the nylon 6,6 and the aluminum silicate or sintered glass are present in a volumetric ratio of about 1:4 to about 1:5; the outer-surface of the shell is gear-shaped with at least six teeth extending between 3-4 mm from the surface of the shell, wherein each tooth of the gear-shaped shell has a tooth base width of 3 to 4 mm and a tooth face width of 1 to 2 and each tooth is separated by a distance of 1 to 2 mm when measured at the base of the tooth; the shell has a cylindrically shaped through hole along at the center of the shell for receiving the core, wherein the core is cylindrically shaped; and the biocarrier has a diameter of 16 to 20 mm and a height of 7 to 9 mm.

21. A method of preparing the biocarrier of claim 1, comprising the steps of:
c) providing one or more cores comprising a porous material for attaching microorganisms; and
d) partially enclosing the one or more porous cores by a shell comprising a polymeric material such that the one or more cores are accessible from an external environment,
wherein at least one of the one or more cores defines a first axis and opposing surfaces along the first axis, such that the opposing surfaces are exposed to the external environment.

22. The method of claim 21, wherein the step of partially enclosing the one or more porous cores comprises injection molding or direct insertion of the one or more cores into the polymeric material.
